(19) United States
(12) Patent Application Publication
(10) Pub. No.: US 2026/0228092 A1
(43) Pub. Date: Aug. 6, 2026

(54) Minimal Frontier-State Set Based Restoration System, Method, and Program

(71) Applicant: KOJI MOCHIZUKI, Suita (JP)

(72) Inventor: KOJI MOCHIZUKI, Suita (JP)

(21) Appl. No.: 19/647,550

(22) Filed: Apr. 14, 2026

(30) Foreign Application Priority Data
Mar. 9, 2026 (JP) 2026-036741

(51) Int. Cl. G06F 11/1446; G06F 16/215; G06F 16/901

(52) U.S. Cl. CPC G06F 11/1469; G06F 16/215; G06F 16/9024; G06F 2201/80

(57) ABSTRACT

A restoration system, method, and program restore a designated target state set on the basis of a dependency graph while reducing persisted and reconstructed state volume. A dependency relation among state elements is represented as a graph, a target state set is specified, and a frontier-state set is selected such that a forward closure from the frontier-state set covers the target state set. Restoration is performed by forward generation, propagation, replay, recomputation, or deterministic regeneration. Reconstructed states may be accepted only after verification, validation, consistency checking, hash comparison, schema checking, quorum checking, or another acceptance check, and the frontier-state set may be augmented and restoration retried when acceptance fails. The invention is applicable to database restoration, cache reconstruction, distributed synchronization, workflow-state regeneration, log compression, and restoration of continuation-relevant states in generative-AI systems.

### CROSS-REFERENCE TO RELATED APPLICATIONS

This application claims priority to Japanese Patent Application No. 2026-036741, filed on 2026 Mar. 9, the entire contents of which are incorporated herein by reference.

### FIELD OF THE INVENTION

The present invention relates to information processing, restoration control, graph-based dependency analysis, and computer-implemented state reconstruction. More particularly, the invention relates to techniques for restoring a designated target state set from a reduced preserved-state set selected on the basis of dependency relations among state elements.

### BACKGROUND OF THE INVENTION

In many information-processing systems, restoration of a desired state commonly relies on preserving checkpoints, snapshots, logs, timestamps, event histories, or large intermediate-state sets. Representative examples include database point-in-time recovery, virtual-machine checkpointing, rollback-based fault recovery, workflow replay, cache-image preservation, and compression or persistence of model or inference states.

Such approaches are often effective, but they tend to preserve either a full state, a broad checkpoint boundary, or a time/history-oriented recovery basis. In many practical settings, however, the operational target is not the entire historic state space, but a designated target state set that only requires a subset of preserved states for successful regeneration. In addition, many practical systems do not merely seek technical recoverability. They seek recoverability under latency budgets, service-level objectives, memory limits, storage budgets, recomputation budgets, fault-isolation constraints, or workload-priority constraints.

For example, a database system may only require restoration of a subset of tables, partitions, index states, or metadata sufficient to resume a designated query path; a cache system may only require regeneration of a subset of cache entries or key-value state blocks needed for hot-path traffic; a distributed workflow may only require reconstitution of states needed for a designated downstream task; a distributed service may need restoration that is constrained by quorum availability or fault domain; and a generative-AI inference system may only require restoration of a subset of context, cache, control, or continuation-related states sufficient to continue designated processing.

Conventional checkpointing and replay approaches do not directly formulate restoration as a problem of selecting a preserved frontier-state set that still guarantees regeneration of a designated target state set on a dependency structure. Even approaches that use dependency information often focus on rollback scope reduction, remediation order, or compressed approximation of missing intermediate stages, rather than on determining a frontier-state basis from which a target set is forward-restorable under explicit dependency semantics and operational constraints.

Further, in practical restoration systems, successful reachability alone is not always sufficient. A reconstructed state may need to be verified, validated, consistency-checked, hash-compared, schema-checked, or quorum-checked before the state is accepted into the restored target state set. Moreover, when verification fails, a practical restoration system should be able to augment the preserved frontier-state basis and retry the restoration process.

Accordingly, there remains a need for a restoration architecture that determines a preserved frontier-state set, preferably of reduced or minimal size, from which a designated target state set can be regenerated by forward reconstruction on the basis of dependency relations, explicit dependency semantics, acceptance criteria, and restoration policies reflecting real system constraints.

### SUMMARY OF THE INVENTION

The present invention provides a restoration system, method, and program centered on determining a frontier-state set from which a designated target state set is regenerable on a dependency graph.

In one aspect, a dependency graph representing dependency relations among a plurality of state elements is constructed or obtained. A target state set T to be restored is specified. A frontier-state set F is determined such that a closure from frontier-state set F under relation R covers the target state set T, where R represents at least part of the dependency or generation relation.

In representative embodiments, the frontier-state set is selected according to one of multiple selection classes. In one class, F is selected as an exact smallest-cardinality frontier-state set under a formal dependency model and stated constraints. In another class, F is selected as a reduced-cardinality frontier-state set obtained by heuristic, approximate, greedy, learned, or policy-based selection. In another class, F is selected to optimize a weighted objective that reflects preservation cost, memory footprint, storage-transfer volume, network-transfer cost, restoration latency, recomputation burden, dependency depth, or combinations thereof. In another class, F is selected as a policy-satisfying frontier-state set that satisfies one or more operational constraints even when exact global minimization is not required.

In another aspect, dependency semantics may include AND-dependency, OR-dependency, or mixed dependency. A downstream state may require all designated predecessor states, any one of multiple predecessor states, one designated group of predecessor states, a threshold-satisfying subset, a quorum-satisfying subset, or another policy-defined logical requirement.

In another aspect, the target state set is restored by preserving the frontier-state set and performing forward generation, propagation, replay, recomputation, deterministic regeneration, or combinations thereof on the basis of the dependency relation. Reconstructed states may be accepted only after verification, validation, consistency checking, hash comparison, schema checking, quorum checking, or another correctness check.

In another aspect, when acceptance of a reconstructed state fails, the system may augment the frontier-state set with one or more additional states, re-run at least part of the forward reconstruction process, and re-check acceptance criteria. In this manner, restoration may proceed as an acceptance-gated restoration loop rather than as a single-pass replay process.

In another aspect, when cyclic dependencies exist, strongly connected components may be identified and contracted, and frontier-state selection may be performed on a contracted graph.

In another aspect, frontier-state selection may be policy-driven and may depend on latency budget, resource availability, service priority, service tier, fault domain, storage budget, recomputation cost, network-transfer budget, memory budget, or combinations thereof.

In another aspect, the target state set may be partial or selective and may include only designated states necessary for a downstream task, designated service continuation, designated workflow continuation, designated quorum recovery, or designated inference continuation, rather than a full historic state.

In another aspect, the invention is applicable to database restoration, cache reconstruction, distributed synchronization, workflow-state regeneration, log or event compression, and restoration of inference or context states in generative-AI systems.

In another aspect, the architecture improves operation of a computer system by controlling what state information is persisted, transferred, reconstructed, and accepted so as to reduce at least one of preserved-state volume, storage-transfer volume, network-transfer volume, memory footprint, restart latency, or recomputation burden relative to preservation of a full historical state, a full target state set, or a broad checkpoint boundary, depending on policy and system topology. In generative-AI embodiments, the restored target state set may include selected classes of continuation-relevant states such as context fragments, selected key-value cache states, decoding-control states, summary states, or retrieval-linked state references rather than a full inference snapshot.

In another aspect, the dependency graph may include one or more validation-enabling states or metadata states that are not themselves members of the target state set but that are required to verify, validate, or accept a reconstructed state.

In another aspect, selective restoration may prioritize a first designated subset associated with a higher service tier, hot path, or shorter latency budget before restoring a second designated subset associated with a lower service tier or background workload.

In another aspect, in query-graph, workflow-graph, or operator-graph embodiments, frontier-state selection may be used to restore only operator states required to resume designated downstream processing rather than reconstructing an entire prior execution state.

In another aspect, the dependency graph may represent one or more substitute dependency paths or replica-based restoration paths, and frontier-state selection may choose among the paths according to the at least one policy factor when an unavailable dependency, a topology constraint, or a service objective is present.

Accordingly, the invention provides a restoration architecture centered on minimal or reduced preserved frontier states, acceptance-gated reconstruction, and policy-aware selective restoration rather than on full-state checkpointing, timestamp rollback, or generic replay alone.

In representative examples, a target set of 100 states may be restored from 12 frontier states, a workflow state originally requiring 250 preserved units under checkpoint-based preservation may instead be restored from 35 preserved frontier units, a distributed service may recover a designated quorum-preserving target state set from a fault-domain-constrained frontier-state set, and a generative-AI inference-state embodiment may reduce preserved-state volume from 80 units to 18 units while preserving designated continuation capability.

### BRIEF DESCRIPTION OF THE DRAWINGS

FIG. 1 illustrates an overall restoration architecture including a dependency-graph module, a target-state specification module, a frontier-selection module, and a reconstruction/acceptance module.

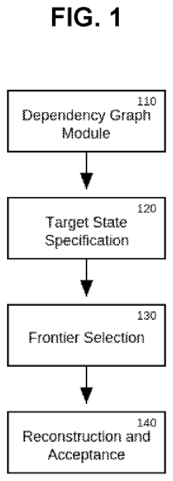

FIG. 2 illustrates an example frontier-selection and restoration flow.

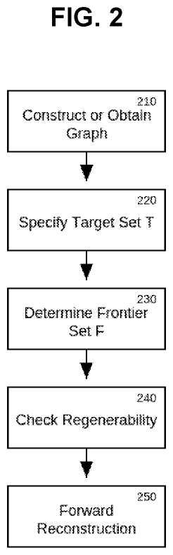

FIG. 3 illustrates an example in which closure(F, R) covers a designated target state set T.

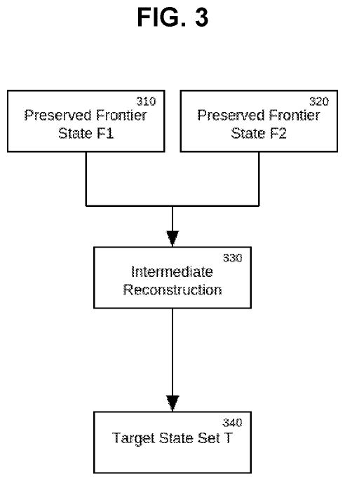

FIG. 4 illustrates an example of strongly connected component contraction before frontier selection.

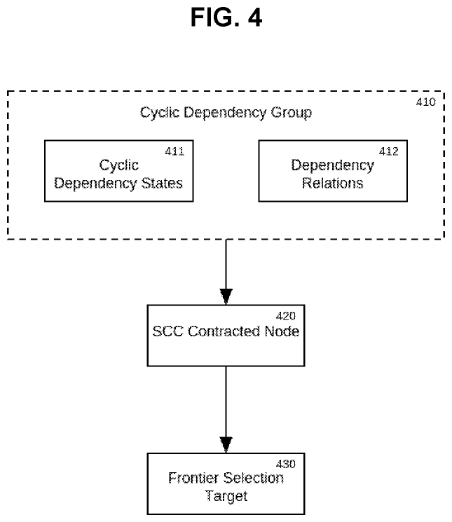

FIG. 5 illustrates a database-restoration embodiment.

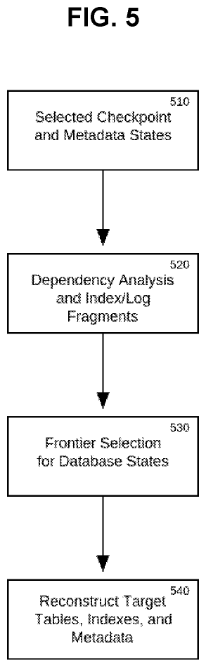

FIG. 6 illustrates a cache and inference-state restoration embodiment.

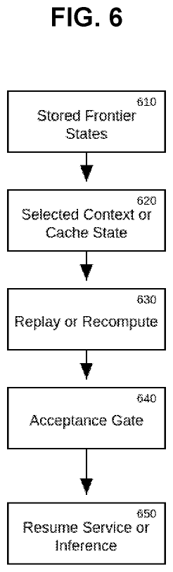

FIG. 7 illustrates a distributed or workflow restoration embodiment.

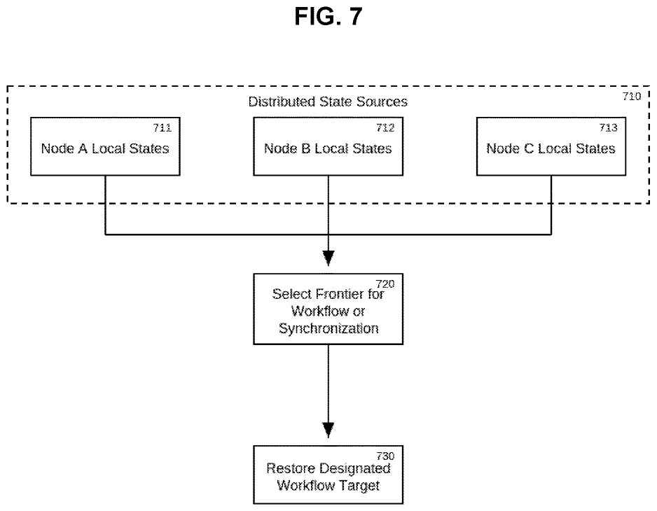

FIG. 8 illustrates example frontier-selection classes including exact, reduced-cardinality, weighted, and policy-satisfying selection.

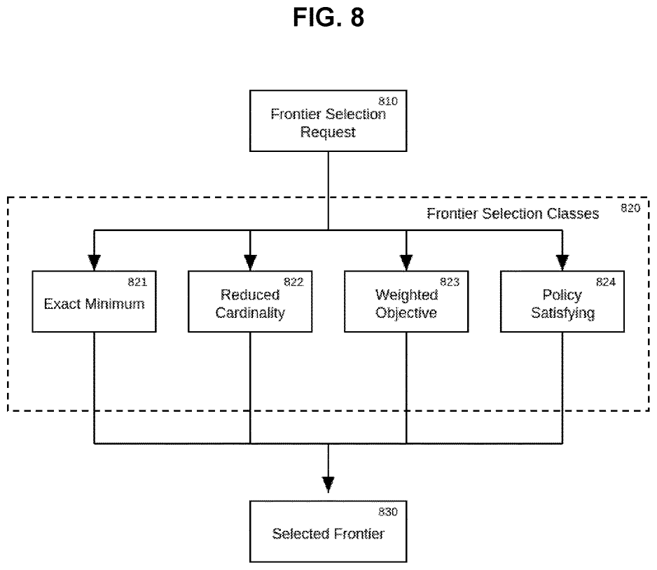

FIG. 9 illustrates example dependency semantics including AND-dependency, OR-dependency, and mixed dependency.

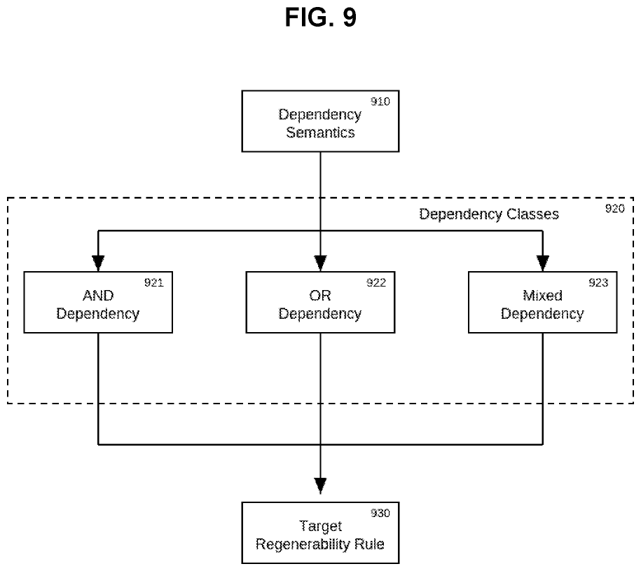

FIG. 10 illustrates an example acceptance gate applied before final restoration, including verification, validation, or metadata-enabled acceptance checking.

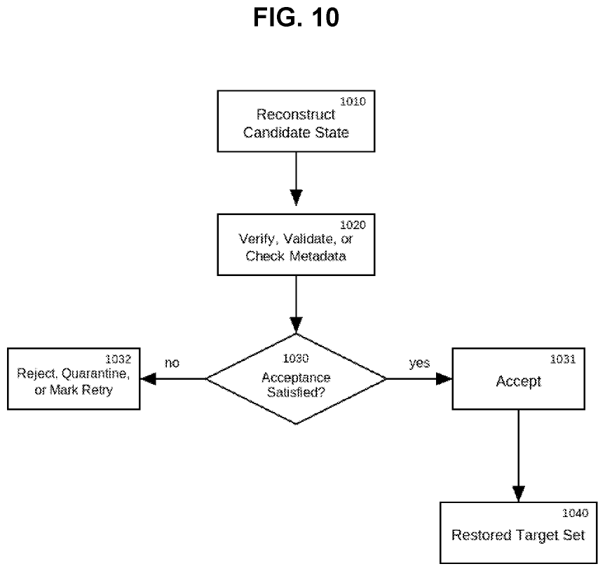

FIG. 11 illustrates an example retry and frontier-augmentation loop executed when acceptance fails.

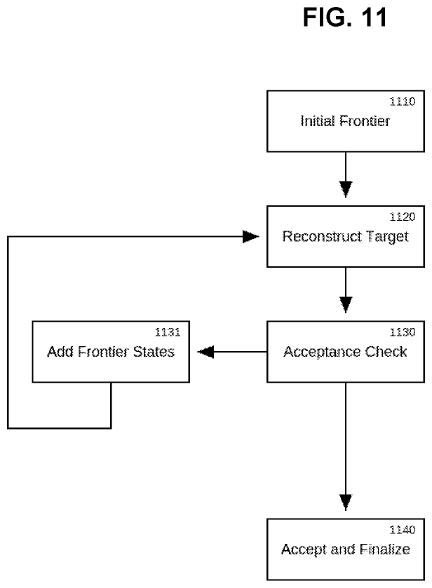

FIG. 12 illustrates an example policy-driven frontier-state selection based on latency budget, resource availability, service priority, service tier, or fault domain.

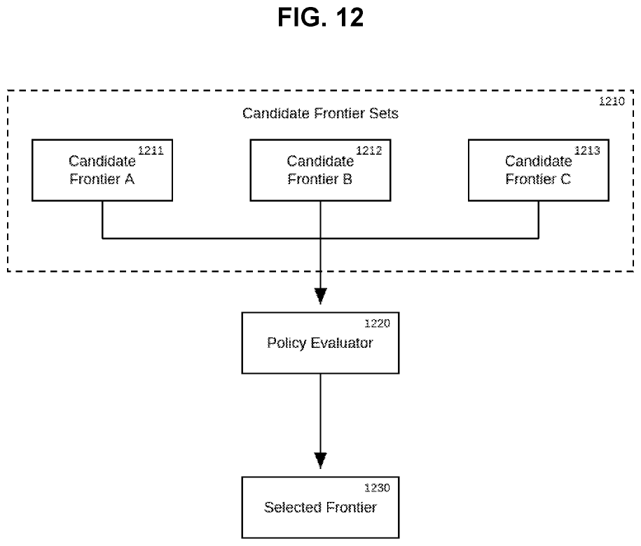

FIG. 13 illustrates an example partial or selective restoration in which only designated operator states in a query graph, workflow graph, or operator graph are restored for downstream resumption.

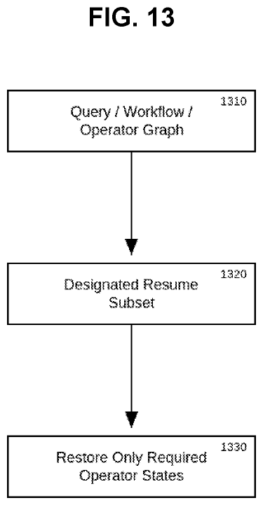

FIG. 14 illustrates an example generative-AI continuation embodiment using selected continuation-relevant state classes.

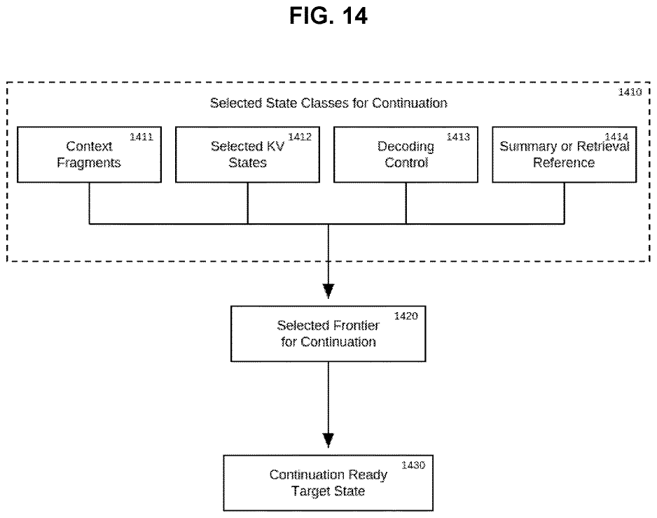

FIG. 15 illustrates an example fault-domain-aware and quorum-aware distributed restoration embodiment including substitute dependency paths or replica-based restoration paths.

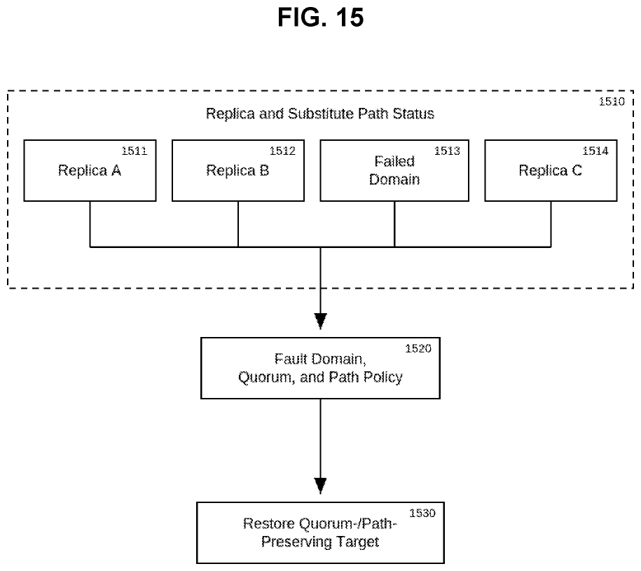

### DETAILED DESCRIPTION OF THE INVENTION

### 1. Overview

Embodiments of the present invention provide a restoration architecture in which a designated target state set is restored not by preserving every potentially relevant state, but by preserving a frontier-state set from which the target state set is regenerable by forward reconstruction on a dependency structure.

For purposes of this specification, a “state element” may include a data block, record, table state, cache entry, key-value state unit, workflow state, computation state, inference state, context state, control state, log-derived state, metadata state, or another restorable state unit. A “dependency relation” may include a generation relation, derivation relation, prerequisite relation, causal relation, synchronization relation, validation-enabling relation, or other relation indicating that one state can be generated, validated, or reconstructed from one or more other states.

### 2. Dependency Graph

A restoration system may construct or obtain a dependency graph G=(V, E) in which nodes represent state elements and edges represent dependency relations. In some embodiments, the graph may be directed. In some embodiments, edges may include labels, weights, timestamps, confidence values, recomputation costs, storage costs, fault-domain metadata, service-priority metadata, or other metadata useful for restoration planning.

2a. Dependency Semantics

In some embodiments, dependency semantics include AND-dependency, OR-dependency, or mixed dependency. Under AND-dependency, a designated downstream state is regenerable only when all required predecessor states are available or reconstructable. Under OR-dependency, the downstream state is regenerable when at least one predecessor state, one group of predecessor states, or one threshold-satisfying subset is available. Under mixed dependency, different parts of the dependency graph may follow different logical requirements, including nested AND/OR structures, grouped alternatives, threshold conditions, quorum requirements, or policy-defined reconstruction rules.

2b. Frontier-Selection Classes

In some embodiments, the system supports multiple frontier-selection classes. A first class uses exact smallest-cardinality selection under a defined graph model and stated restoration constraints. A second class uses reduced-cardinality selection obtained by heuristic, approximate, greedy, learned, or policy-based search. A third class uses weighted optimization in which a frontier-state set is selected to optimize a cost function involving preservation cost, restoration latency, network-transfer volume, memory footprint, recomputation burden, dependency depth, or combinations thereof. A fourth class uses policy-satisfying selection in which the selected frontier-state set need not be globally minimal but satisfies one or more service, resource, or fault-tolerance requirements.

### 3. Target State Set

A target state set T is specified. The target state set may include one or more designated states that are to be restored, regenerated, or made available for subsequent processing. The target state set need not include all historical states in the system. In some embodiments, the target state set is partial or selective and includes only states required for a designated downstream task, designated service continuation, designated workflow continuation, designated quorum recovery, or designated inference continuation, rather than a full historic state.

### 4. Frontier-State Selection

A frontier-state set F is determined such that the target state set T is regenerable from F through dependency-based forward reconstruction. In some embodiments, F is selected such that closure(F, R) covers the target state set T, where R represents at least part of the dependency or generation relation.

In preferred embodiments, F is selected as a smallest-cardinality set or reduced-cardinality set satisfying one or more restoration conditions. In some embodiments, exact smallest-cardinality selection is performed under a defined graph model, dependency semantics, and restoration constraints. In other embodiments, a reduced-cardinality frontier-state set is selected by heuristic, approximate, greedy, learned, or policy-based selection. Accordingly, the invention is not limited to exact global minimization in every graph.

In some embodiments, the optimization target may be cardinality minimization. In other embodiments, weighted preservation cost, restoration latency, dependency depth, memory footprint, resource availability, network-transfer budget, or combinations thereof may be optimized. In some embodiments, frontier-state selection is policy-driven and depends on latency budget, resource availability, service priority, service tier, fault domain, storage budget, recomputation cost, or combinations thereof.

4a. Policy-Driven and Service-Priority Selection

In some embodiments, frontier-state selection is conditioned on service-level objectives or business-priority constraints. For example, a restoration controller may select a first frontier-state set for a latency-sensitive hot path, a second frontier-state set for a lower-priority background workload, and a third frontier-state set for a fault-isolated recovery workflow. In this manner, the restoration architecture supports differentiated restoration outcomes for different workloads or service classes on the basis of the same underlying dependency graph.

### 5. Forward Reconstruction

After selecting F, the system restores the target state set T by forward generation, propagation, replay, recomputation, deterministic regeneration, or combinations thereof. In some embodiments, the restoration proceeds in topological order or in another dependency-consistent order. In some embodiments, restoration is executed only for designated downstream-needed states rather than for all reachable states in the graph.

### 5A. Acceptance Gate, Verification, and Retry

In some embodiments, a reconstructed state is verified, validated, consistency-checked, hash-compared, schema-checked, quorum-checked, or otherwise tested for correctness before being accepted into the restored target state set. In some embodiments, such acceptance depends on one or more validation-enabling states or metadata states that are not themselves members of the target state set but that are required to verify, validate, or accept the reconstructed state. A reconstructed state that fails acceptance may be rejected, quarantined, deferred, or marked for retry.

In some embodiments, when acceptance fails, the system augments the frontier-state set with one or more additional states selected from upstream dependencies, alternative dependency paths, metadata states, validation-enabling states, or policy-selected preservation candidates. The system may then repeat at least part of the reconstruction process. In this manner, restoration may proceed as an acceptance-gated restoration loop in which the frontier-state basis is adaptively strengthened until designated acceptance conditions are satisfied or a termination policy is reached.

### 6. Cyclic Dependencies

When cycles exist in the dependency graph, strongly connected components may be identified. A contracted graph may then be formed. Frontier-state selection may be executed on the contracted graph, and restoration may then proceed on the original graph or an expanded representation corresponding to the contracted components.

### 7. Embodiments

### 7.1 Database Restoration

In one embodiment, nodes correspond to database states such as table fragments, partition states, index fragments, metadata states, validation states, or transaction-derived materialized states. Instead of storing all recoverable states, the system preserves a frontier-state set sufficient to regenerate designated target states such as selected query-serving states, selected consistency-preserving states, or selected restart-critical states.

### 7.2 Cache Restoration

In one embodiment, nodes correspond to cache entries, cache blocks, key-value structures, feature fragments, freshness metadata, or intermediate cache layers. A reduced frontier-state set may be preserved so that designated cache states can be reconstructed without preserving the full cache image. In some embodiments, hot-entry or service-critical cache segments are restored prior to lower-priority cache segments.

### 7.3 Distributed Synchronization

In one embodiment, nodes correspond to distributed states across multiple computational agents, services, or replicas. A frontier-state set may be selected to enable restoration or re-synchronization of designated target states while reducing preserved-state volume.

7.3a. Fault-Domain-Aware and Quorum-Aware Restoration

In some distributed embodiments, frontier-state selection considers fault domain, replica placement, node class, or quorum sufficiency. For example, when one availability zone, rack group, or shard group is unavailable, the system may select a frontier-state set that avoids unavailable dependencies while still enabling restoration of a designated quorum-preserving target state set. In this manner, distributed restoration can be made both dependency-aware and topology-aware.

In some embodiments, the dependency graph explicitly represents substitute dependency paths, fallback dependency paths, or replica-based restoration paths. When one dependency path is unavailable, violates policy, or fails acceptance, the system may select another path or replica path according to at least one policy factor such as fault domain, service tier, latency budget, or resource availability.

### 7.4 Generative-AI Inference-State Restoration

In one embodiment, nodes correspond to context fragments, inference-stage states, memory slots, cache units, retrieval-linked states, summary states, or other states relevant to continuation of inference. The invention may preserve a frontier-state set sufficient to regenerate designated inference-related target states without preserving the full intermediate state history.

### 7.4A. Selected State Classes for Inference Continuation

In some embodiments, the target state set for an inference continuation operation includes selected continuation-relevant state classes rather than a full snapshot. Such state classes may include prompt-context states, selected key-value cache states, decoding-control states, selected layer states, summary states, retrieval references, or combinations thereof. Frontier-state selection may therefore restore continuation capability with lower preserved-state volume than a full-snapshot approach while retaining designated continuation correctness criteria.

### 7.5 Partial and Selective Restoration

In some embodiments, only a designated subset of reachable states is restored. A restoration controller may identify states needed for a downstream task, a selected service endpoint, a designated workflow stage, a selected tenant, or a designated user session, and restore only those states and their accepted dependencies. In query-graph, workflow-graph, or operator-graph embodiments, the designated subset may include only operator states required to resume designated downstream processing rather than an entire prior execution state. This selective restoration mode may reduce restart time, reduce memory pressure, reduce storage transfer, and reduce network activity relative to restoring the full historical state space.

### 7.6 ASCII Notation Clarification

In this specification, the expression that a closure from F under relation R covers T means that repeated application of the dependency or generation relation starting from frontier-state set F reaches all states in target state set T that are required by the selected restoration policy. References to minimizing the cardinality of F mean minimizing the number of preserved frontier states under the applicable model or policy.

### 8. Example Mathematical Framing

In one example, given target state set T and relation R, a frontier-state set F is selected such that a closure from F under relation R covers T. In some embodiments, F is selected to minimize the cardinality of F under a defined formal model. In other embodiments, F is selected as a reduced-cardinality set or by minimizing a weighted preservation cost function under heuristic, approximate, or policy-based selection.

In one representative weighted form, the system may optimize:
C(F)=a*Storage(F)+b*Latency(F)+c*Memory(F)+d*Network(F)+e*Recompute(F)
where the coefficients may be determined by configuration, service class, policy, runtime condition, or combinations thereof.

### 8A. Representative Working Examples

### 8A.1 Database-Restoration Example

In one example, a dependency graph contains 100 target states to be restored. Dependency analysis determines that preserving 12 frontier states is sufficient to regenerate the 100 target states through closure(F, R). In such a case, preserved-state count is reduced from 100 to 12, corresponding to an 88% reduction in preserved-state volume. This example supports embodiments in which the frontier-state set is smaller than the target-state set.

### 8a.2 Checkpoint-Comparison Example

In another example, a workflow execution state would require preservation of 250 state units under a full-checkpoint approach. Under a frontier-preservation approach, 35 state units are preserved and the remaining 215 state units are reconstructed through replay, propagation, or recomputation. This corresponds to an 86% reduction in preserved-state volume relative to checkpoint-based preservation.

### 8a.3 Weighted-Cost Example

In another example, candidate frontier set A preserves 10 states with storage cost 10 and recomputation cost 90, candidate frontier set B preserves 14 states with storage cost 14 and recomputation cost 40, and candidate frontier set C preserves 20 states with storage cost 20 and recomputation cost 20. Depending on policy, the system may select candidate C to minimize total weighted cost, candidate B to satisfy a memory-versus-latency tradeoff, or another candidate to satisfy a service-tier-specific policy.

### 8a.4 Cyclic-Dependency Example

In another example, states s1, s2, and s3 form a cycle, while states s4 and s5 are downstream of that cycle and belong to the target-state set. The system contracts the cycle into a strongly connected component, selects a representative frontier-state basis on the contracted graph, reconstructs the strongly connected component, and then restores s4 and s5 by forward generation. This example supports SCC-based embodiments.

### 8a.5 Generative-AI Inference-State Example

In another example, a target inference state includes prompt-context state, selected key-value cache state, and decoding-control state. A full inference snapshot would preserve 80 state units. Frontier-state analysis determines that preserving 18 state units is sufficient to regenerate the target inference state, corresponding to a 77.5% reduction in preserved-state volume. Remaining states are restored through replay or deterministic regeneration.

### 8a.6 Distributed-Workflow Example

In another example, a distributed workflow includes 40 checkpoint-like states. Dependency analysis determines that 9 frontier states are sufficient to restore the designated workflow state, corresponding to a 77.5% reduction in preserved-state count.

### 8a.7 Acceptance-Gated Retry Example

In another example, an initially selected frontier-state set fails a quorum or consistency acceptance check after reconstruction of a designated target state. The system therefore augments the frontier-state set with additional metadata states and one alternative upstream dependency path, re-runs forward reconstruction, and then accepts the reconstructed target state after the acceptance gate is satisfied.

### 8a.8 Service-Priority Example

In another example, a first target state set associated with an interactive service path is restored from a first frontier-state set selected under a low-latency policy, while a second target state set associated with batch work is restored from a second frontier-state set selected under a lower preservation-cost policy. This example supports embodiments in which multiple frontier-state sets are selected from the same dependency graph according to different service policies.

### 9. Technical Effects

Embodiments of the invention may improve operation of a computer system by controlling what state information is preserved, transferred, reconstructed, verified, and accepted. Depending on the selected frontier class, policy, graph topology, and target-state scope, the invention may reduce preserved-state count, memory footprint, storage-transfer volume, network-transfer volume, restart time, and recomputation burden relative to preserving a full target state set, a full historical state set, or a broad checkpoint boundary. In database embodiments, the invention may reduce stored checkpoint size and replay scope. In cache embodiments, the invention may reduce hot-cache persistence volume and defer rebuilding of unnecessary cold-cache segments. In distributed embodiments, the invention may reduce cross-node synchronization traffic and may improve restoration under fault-domain constraints. In generative-AI embodiments, the invention may reduce continuation-state persistence volume and improve continuation control relative to full-snapshot persistence.

### 10. Implementation

The invention may be implemented in software, firmware, hardware, or combinations thereof. Modules may communicate through APIs, shared memory, message passing, distributed middleware, or storage services. The invention may also be embodied in one or more non-transitory computer-readable media storing instructions that, when executed, cause one or more processors to perform dependency-graph construction, target-state specification, frontier-state selection, policy-aware or acceptance-gated target-state restoration, and frontier augmentation when applicable.

### 11. Scope

The invention is not limited to the embodiments expressly described herein. Variations, substitutions, selection policies, optimization criteria, acceptance policies, domain-specific adaptations, and equivalent implementations falling within the scope of the claims are intended to be covered.

1. A computer-implemented restoration method comprising:
constructing or obtaining a dependency graph representing dependency relations among a plurality of state elements;
specifying a designated target state subset to be restored for continuation of a selected candidate process, workflow, service, or inference;
determining, based on the dependency graph, a frontier-state set from which the designated target state subset is regenerable through forward generation or propagation;
performing forward reconstruction from the frontier-state set to reconstruct the designated target state subset;
verifying, validating, consistency-checking, hash-comparing, schema-checking, or quorum-checking the reconstructed designated target state subset before accepting the reconstructed designated target state subset; and
when the reconstructed designated target state subset is not accepted, augmenting the frontier-state set with one or more additional states and re-performing at least part of the forward reconstruction.

2. The method of claim 1, wherein determining the frontier-state set comprises selecting a set satisfying a closure from F under relation R covers T, where F is the frontier-state set, R is at least part of the dependency relation, and T is the target state set.

3. The method of claim 1, wherein determining the frontier-state set comprises selecting, in respective embodiments, (i) an exact smallest-cardinality frontier-state set, (ii) a reduced-cardinality frontier-state set, (iii) a weighted-cost-optimized frontier-state set, or (iv) a policy-satisfying frontier-state set.

4. The method of claim 3, wherein the reduced-cardinality frontier-state set is selected by heuristic, approximate, greedy, learned, or policy-based selection, and wherein the weighted-cost-optimized frontier-state set is selected using a cost function based on at least one factor selected from preservation cost, restoration latency, dependency depth, memory footprint, storage-transfer volume, network-transfer volume, recomputation burden, or combinations thereof.

5. The method of claim 1, further comprising contracting strongly connected components in the dependency graph before determining the frontier-state set.

6. The method of claim 1, wherein the dependency relation includes AND-dependency, OR-dependency, or mixed dependency semantics.

7. The method of claim 1, wherein restoring the target state set further comprises verifying, validating, consistency-checking, hash-comparing, schema-checking, or quorum-checking a reconstructed state before accepting the reconstructed state.

8. The method of claim 7, wherein, when the reconstructed state is not accepted, the method further comprises augmenting the frontier-state set with one or more additional states and re-performing at least part of the forward reconstruction.

9. The method of claim 1, wherein the frontier-state set is selected according to at least one policy factor selected from latency budget, resource availability, service priority, service tier, fault domain, storage budget, recomputation cost, or combinations thereof.

10. The method of claim 1, wherein the target state set is partial or selective and includes only designated states required for a downstream task, service continuation, workflow continuation, quorum recovery, or inference continuation.

11. A restoration system comprising:
a dependency-graph module configured to construct or obtain a dependency graph representing relations among state elements;
a target-state specification module configured to specify a designated target state subset to be restored for continuation of a selected candidate process, workflow, service, or inference;
a frontier-selection module configured to determine, on the dependency graph, a frontier-state set from which the designated target state subset is regenerable; and
a reconstruction-and-acceptance module configured to:
restore the designated target state subset by forward generation or propagation from the frontier-state set,
verify, validate, consistency-check, hash-compare, schema-check, or quorum-check a reconstructed designated target state subset before acceptance, and
when acceptance is not satisfied, augment the frontier-state set and re-perform at least part of the restoration.

12. The system of claim 11, wherein the frontier-selection module is configured to determine, in respective embodiments, an exact smallest-cardinality frontier-state set, a reduced-cardinality frontier-state set, a weighted-cost-optimized frontier-state set, or a policy-satisfying frontier-state set.

13. The system of claim 11, wherein the frontier-selection module is configured to operate on a graph contracted by strongly connected components.

14. The system of claim 11, wherein the frontier-selection module or the reconstruction-and-acceptance module applies at least one optimization or policy criterion selected from frontier cardinality, preservation cost, restoration latency, dependency depth, memory footprint, resource availability, service priority, service tier, fault domain, or combinations thereof, and wherein restoration is partial or selective for a designated subset of target states.

15. A non-transitory computer-readable medium storing instructions that, when executed by one or more processors, cause the one or more processors to:
construct or obtain a dependency graph representing dependency relations among state elements;
specify a designated target state subset to be restored for continuation of a selected candidate process, workflow, service, or inference;
determine, on the dependency graph, a frontier-state set from which the designated target state subset is regenerable according to at least one policy factor;
perform forward reconstruction from the frontier-state set to reconstruct the designated target state subset;
apply acceptance-gated verification to the reconstructed designated target state subset; and
when acceptance is not satisfied, augment the frontier-state set and retry at least part of the restoration.

16. A non-transitory computer-readable medium storing instructions that, when executed by one or more processors, cause the one or more processors to:
construct or obtain a dependency graph representing dependency relations among state elements;
specify a target state set to be restored;
determine, on the dependency graph, a frontier-state set from which the target state set is regenerable according to at least one policy factor; and
restore only a designated subset of target states by forward reconstruction from the frontier-state set.

17. The non-transitory computer-readable medium of claim 16, wherein the instructions further cause the one or more processors to apply acceptance-gated verification of a reconstructed state and, when acceptance is not satisfied, augment the frontier-state set and retry at least part of the restoration.

18. The non-transitory computer-readable medium of claim 16, wherein the designated subset of target states includes one or more generative-AI continuation-relevant states selected from context fragments, key-value cache states, decoding-control states, summary states, retrieval references, or combinations thereof, and wherein executing the instructions reduces preservation cost relative to preserving a full historical state, a full target state set, or a broad checkpoint boundary.

19. The method of claim 1, wherein the dependency graph further includes one or more validation-enabling states or metadata states that are not members of the target state set but are required to validate, verify, or accept a reconstructed state.

20. The system of claim 11, wherein the reconstruction-and-acceptance module is configured to restore a first designated subset of target states associated with a higher service tier, hot path, or shorter latency budget before restoring a second designated subset of target states.

21. The system of claim 11, wherein the frontier-selection module is configured to select the frontier-state set for a query graph, workflow graph, or operator graph so as to restore only operator states required to resume designated downstream processing.

22. The non-transitory computer-readable medium of claim 16, wherein the instructions further cause the one or more processors to represent one or more substitute dependency paths or replica-based restoration paths in the dependency graph and to select among the paths according to the at least one policy factor.
